(19) United States
(12) Patent Application Publication
(10) Pub. No.: US 2017/0233926 A1
(43) Pub. Date: Aug. 17, 2017

(54) APPARATUS AND METHOD FOR MOTOR BRAKING IN WASHING MACHINE

(71) Applicants: Dongbu Daewoo Electronics Corporation, Seoul (KR); KOREA NATIONAL UNIVERSITY OF TRANSPORTATION, Chungju-si (KR)

(72) Inventors: Hee Sok JUNG, Seoul (KR); Myung Joon NAM, Chungju-si (KR); Jong Hyun KIM, Chungju-si (KR); Kwan Yuhl CHO, Chungju-si (KR); Hag Wone KIM, Chungju-si (KR)

(21) Appl. No.: 15/398,559

(22) Filed: Jan. 4, 2017

(30) Foreign Application Priority Data
Feb. 16, 2016 (KR) 10-2016-0018031

(51) Int. Cl. D06F 37/30; H02P 6/08; H02P 6/17; H02P 21/36; H02P 27/06

(52) U.S. Cl. CPC D06F 37/306; H02P 21/36; H02P 27/06; H02P 6/17; H02P 6/08

(57) ABSTRACT

A motor braking unit for a washing machine that offers high braking efficiency while preventing overcharging a capacitor in a DC link. The motor braking unit determines a current to be supplied to the motor based on a detected speed of the motor. The motor braking unit dynamically monitors the voltage on the capacitor against a reference voltage. If the capacitor voltage is lower than the reference voltage, the current component Iq is increased to increase the braking torque; and if the capacitor voltage is greater than the reference voltage, the current Iq component is decreased to prevent overcharging on the capacitor by the motor.

### CROSS-REFERENCE TO RELATED APPLICATION

This application is based on and claims priority from Korean Patent Application No. 10-2016-0018031, filed on Feb. 16, 2016, the disclosure of which is incorporated herein in its entirety by reference for all purposes.

### TECHNICAL FIELD

The present disclosure relates to washing machines, and in particular to a motor braking mechanism for washing machines.

### BACKGROUND OF THE INVENTION

There is a trend in the washing machine market that a washing machine offers a variety of options of operational variety. Implementing various operational variety requires precise control over the motor in the washing machine.

In general, a washing machine uses a motor and a control unit to drive the washing tub to rotate. For precise control over the motor, an inverter is typically used. FIG. 1 is a block diagram illustrating the configuration of a motor control system including an inverter in a washing machine.

Referring to FIG. 1, the conventional motor control system includes a rectification unit 101 which rectifies AC power source into DC power, and a capacitor 102 which stores the power rectified by the rectification unit 101 and provides stable DC power.

A stable DC power is supplied to the inverter 103 and then to a motor 105 through transistors. In addition, to prevent overcharging the DC link capacitor 102 during motor braking, the motor control system uses a voltage detecting unit 104 to detect the voltage on the capacitor 102. The detected voltage value is sent to the microcomputer 107.

To control the motor 105, a stator current of the motor 105 and a rotor position are detected by a sensor 106 and the detected information is also sent to the microcomputer 107. The microcomputer 107 transmits on/off signals of the transistor to the inverter 103 to allow the inverter 103 to supply a desired voltage to the motor 105 based on the voltage on the capacitor 102, the stator current and the rotor position information of the motor 105.

When the washing machine is in operation, the motor 105 drives the washing tub to rotate. When the washing tub is to stop rotating, e.g., as scheduled in a washing operational fashion, the motor 105 is braked. For motor braking, a current is applied to the motor 105 to generate a counter electromotive force for braking torque. The counter electromotive force tries to cause the motor 105 to rotate in a reversed direction.

In this case, energy generated from the counter electromotive force of the motor 105 may be transmitted to a power unit through a transistor which is activated for the braking torque of the motor 105. The energy may be charged into DC link capacitor 102. The voltage detecting unit 104 senses the voltage on the capacitor 102 and sends the sensed value to the microcomputer 107.

In response, the microcomputer 107 determines whether the voltage on the capacitor 102 exceeds a prescribed limit. If yes, the microcomputer 107 operates to decrease the braking torque of the motor 105 by transferring the energy generated from the motor 105 to the capacitor 102. If the voltage on the capacitor 102 is lower than the limit, the braking torque maintains until the motor 105 is stopped. In the braking operation, energy generated by the motor 105 is dissipated by charging the capacitor 102. In a conventional motor control system of a washing machine, the capacitor 102 is repeatedly charged and discharged as described above during motor braking.

Unfortunately, the microcomputer 107 cannot generate an optimal braking torque during a high speed operation of the washing machine. This is because that the voltage applied to the motor 105 is dropped due to various factors including a design state of the motor 105, a limit of the allowable voltage across the capacitor 102, and the effect on the counter electromotive force of the motor 105.

More specifically, as shown in FIG. 2, Imax 200 corresponds to current limit set to protect the inverter 103 and the motor 105; Vmax 202 corresponds to the current range which can be applied to the motor 105 based on the voltage on the DC link capacitor 102 at a given speed of the motor. A power limit, Pg=Pr 204 corresponds to a braking operation point in which the power generated from the rotor of the motor 105 by the washing tub equals an internal winding resistance such that the power transmitted to the capacitor 102 is equal to “0.”

Thus, the operation point for a stable braking operation should be located within the graph circles which correspond to the current limit 200 and the voltage limit 202. It is preferred that an operation point is located on the circumference which represents a power limit 204 such that the power transmitted to the capacitor 102 is equal to “0.” Further, for rapid braking, the motor 105 should have the highest current in the negative direction of the q-axis within the range that satisfies the three conditions above, so that the motor 105 can generate the highest braking torque. For example, when the motor 105 rotates at 400 rpm, the braking operation point in the circled number \textcircled{1} in FIG. 2 can be an optimal braking operation point in view of the three conditions above.

However, if braking is activated when the motor rotates at a high speed (e.g., 1000 rpm), the braking operation point in the circled number \textcircled{2} of FIG. 2 can be used as an optimal braking operation point. This is problematic because the conventional motor control system does not take into account a voltage limit of the inverter. Thus, current control may not be performed correctly as the inverter 103 has a voltage limit and cannot supply a current corresponding to the braking operation point in the circled number (to the motor 105. In this case, motor braking may be unstable.

In other words, conventionally, the braking torque is determined by factoring the voltage limit of the capacitor 102 to prevent overcharge on the DC link capacitor 102.

However, if the motor 105 rotates at a high speed, the voltage and the current applied to the motor 105 from the inverter 103 may be limited due to the effect of the counter electromotive force. If the voltage limit from the inverter 103 is not considered, the DC link voltage controller may not function correctly, thereby being unable to curb the rise of the voltage on the DC link capacitor 102.

### SUMMARY OF THE INVENTION

Accordingly, embodiments of the present disclosure provide an improved braking mechanism on washing machines. In a motor braking operation, the motor generates a braking torque that is pre-calculated based on a voltage limit on a DC link capacitor and a voltage limit to be input from an inverter to the motor. Advantageously braking of the motor can be controlled in a stable state regardless of the rotational speed of the motor. The motor may be a permanent magnet (PM) synchronous motor.

In accordance with the present disclosure, during braking of a PM synchronous motor on a washing machine, a braking torque of the motor can be calculated and applied to the motor based on a voltage limiting condition of the DC link capacitor and a voltage limiting condition to be inputted from an inverter to the motor, thereby capable of stably controlling the braking of the motor even during a low speed or high speed operation of the washing machine.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a block diagram illustrating a configuration of a motor control system of an inverter washing machine;

FIG. 2 is a graph illustrating an example setting of a braking torque operation point depending on the speed of the washing machine motor;

FIG. 3 is a block diagram illustrating a configuration of an exemplary braking unit of a washing machine in accordance with an embodiment of the present disclosure;

FIG. 4 is a flowchart illustrating an exemplary operation for the braking control in the braking unit of the washing machine in accordance with an embodiment of the present disclosure;

FIG. 5 is a graph illustrating a braking torque operation point movement corresponding to the speed of the washing machine motor in accordance with an embodiment of the present disclosure; and

FIGS. 6 and 7 are waveform graphs illustrating a DC link capacitor voltage, dq-aixs current, and speed variations of the motor when braking of the washing machine motor in accordance with embodiments of the present disclosure.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

One or more exemplary embodiments of the present disclosure will be described more fully hereinafter with reference to the accompanying drawings, in which one or more exemplary embodiments of the disclosure can be easily determined by those skilled in the art. As those skilled in the art will realize, the described exemplary embodiments may be modified in various different ways, all without departing from the spirit or scope of the present disclosure, which is not limited to the exemplary embodiments described herein.

It is noted that the drawings are schematic and are not necessarily dimensionally illustrated. Relative sizes and proportions of parts in the drawings may be exaggerated or reduced in their sizes, and a predetermined size is just exemplificative and not limitative. The same reference numerals designate the same structures, elements, or parts illustrated in two or more drawings in order to exhibit similar characteristics.

The exemplary drawings of the present disclosure illustrate ideal exemplary embodiments of the present disclosure in more detail. As a result, various modifications of the drawings are expected. Accordingly, the exemplary embodiments are not limited to a specific form of the illustrated region, and for example, include a modification of a form by manufacturing.

Hereinafter, the embodiments operating principles of the present disclosure will be described in detail with reference to the accompanying drawings. In the following description, well-known functions or constitutions will not be described in detail if they would unnecessarily obscure the features of the subject matter present disclosure. Further, the terms to be described below are defined in consideration of functions in the present disclosure and may vary depending on intentions or practices of a user or an operator. Accordingly, the definition may be made on a basis of the content throughout the specification.

Disclosed herein provide a breaking control method in which a braking operation point is determined to satisfy the current and voltage limits to be supplied to a motor as well as to prevent a DC link capacitor from being overcharged by the motor during braking. This can advantageously improve stability in motor braking regardless of the rotational speed of the motor.

An exemplary process of determining a current limit (Imax) 200, a voltage limit (Vmax) 202, and a power limit (Pg=Pr) 204 is described below.

Three conditions are to be considered for stable braking, including: a current limit 200 for protection of the inverter 103 and the motor 105, a power limit 204 for the power transmitted to the DC link from the motor 105 such that the DC link capacitor 102 is not over-charged, and a voltage limit 202 on the DC link capacitor 102. The voltage limit 202 imposes a limit on the current to be supplied to the motor 105.

First, the current limit 200 can be calculated as in Equation 1 below.

i_{d}²+i_{q}²=Iₘₐₓ² [EQUATION 1]

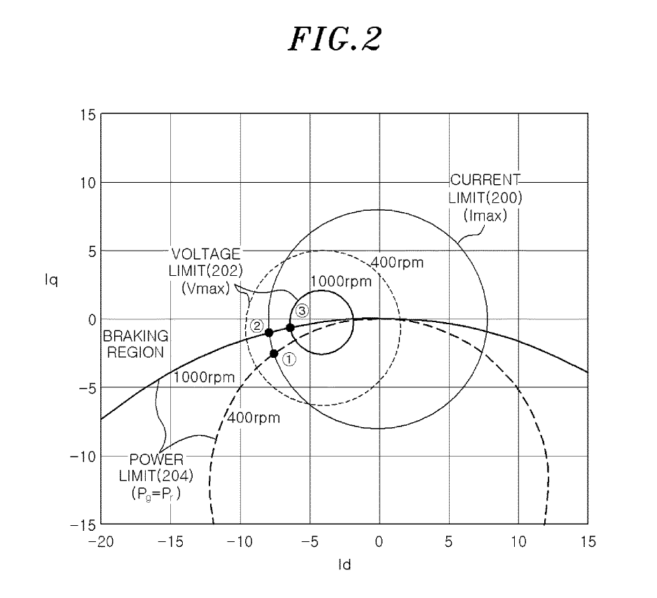

In Equation 1, i_{d} represent current component magnitudes in the dq-axis plane for each axis in FIG. 2. Imax represents a maximum value of a phase current flowing through the inverter 103. In this case, a current components satisfying Equation 1 are used for stable motor driving.

Next, a power generated from the motor 105, a power generated by the counter electromotive force at the braking operation point which is equal in magnitude of the power consumed in the winding resistance within the motor 105, and a power consumed in the winding resistance may be defined for the power limit (Pg=Pr) 204.

The power generated by the counter electromotive force of the motor 105 may be calculated as Equation 2 below.

P_{g}=−Tₑωₘ=−3/2φ_{f}ωᵣi_{q} [EQUATION 2]

In Equation 2, P_{g} represents a power generated by the motor 105, and Tₑ represents a torque generated by the motor 105. ωₘ and ωᵣ represent a mechanical speed and an electrical speed of the motor 105 respectively, and φ_{f} represents a constant of the counter electromotive force of the motor 105.

The power consumed due to winding resistance in the motor 105 may be calculated as Equation 3 below.

Pᵣ=3/2rₛ)i_{d}²+i_{q}² [Equation 3]

In Equation 3, Pᵣ represents a magnitude of the power consumed due to the winding resistance; rₛ represents a phase resistance by internal winding of the motor. According to the power limiting condition, to make the average value of the power transmitted to the capacitor 102 equal to “0(zero),” power generated by the counter electromotive force of the motor 105 needs to be equal to the power consumed by the winding resistance of the motor 105.

In other words, the right side of Equation 2 needs to be equal to the right side of Equation 3:

$${i}_{d}^{2} + {( {i}_{q} + \frac{{ϕ}_{f} {ω}_{γ}}{2 {r}_{s}} )}^{2} = {( \frac{{ϕ}_{f} {ω}_{γ}}{2 {r}_{2}} )}^{2} \qquad [ Equation 4 ]$$

If the power generated by the motor 105 is higher than the power consumed due to the winding resistance within the motor 105, the braking operation point is located inside the circumference representing the power limit 204 (shown in FIG. 2). Conversely, if the power consumed due to the winding resistance is higher than the power generated from the motor 105, the braking operation point is located outside the circumference of the power limit 204. To achieve stable braking, the braking operation point of the motor 105 needs to be located outside or on the boundary line, e.g., on the circumference of the power limit 204 as shown in FIG. 2.

The voltage limit 202 may be calculated as in Equation 5 below.

(rₛi_{d}−ωᵣL_{q}i_{q})²+(rₛi_{q}+ωᵣL_{d}i_{d}+φ_{f}ωᵣ)²≦Vₘₐₓ² [Equation 5]

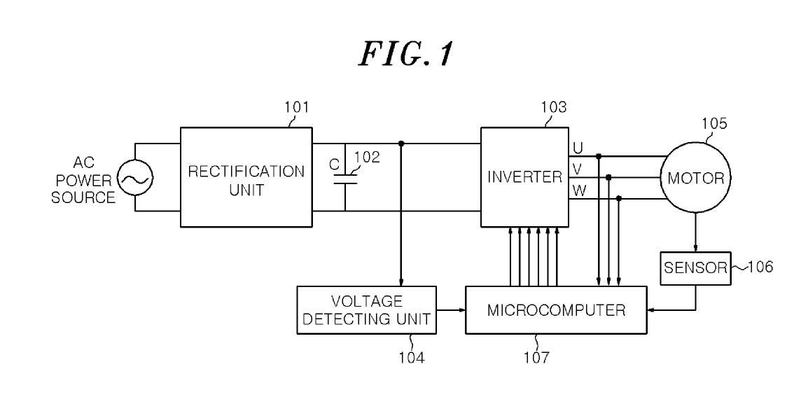

In Equation 5, Ld and Lq represent d-axis and q-axis inductances, respectively; Vmax represents a maximum voltage which is applied to a phase of the motor 105 by the inverter 103 from the voltage on a given DC link capacitor 102 as shown in FIG. 1.

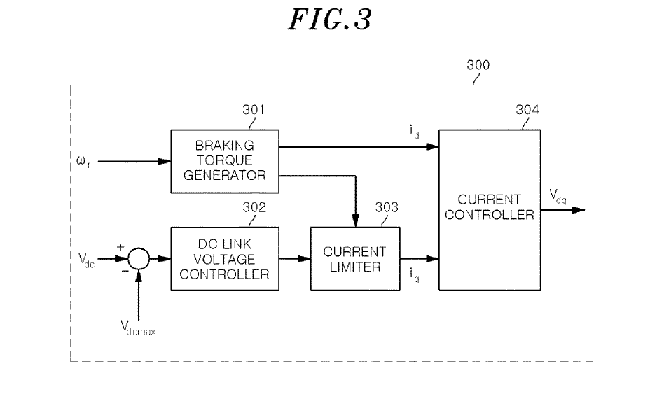

The process of calculating a braking torque which satisfies the three conditions (Equation 1, Equation 4, Equation 5) above is described in greater detail below, with reference to FIG. 3 showing the braking unit of the washing machine.

FIG. 3 illustrates the configuration of an exemplary braking unit on a washing machine in accordance with an embodiment of the present disclosure. The braking unit 300 may include a braking torque generator 301, a DC link voltage controller 302, a current limiter 303, and a current controller 304. The braking unit 300 may be implemented on the microcomputer 107 of the motor control system in the washing machine as shown in FIG. 1, or may be can be implemented as a separate apparatus as well.

The braking torque generator 301 calculates current components Id, Iq which satisfy the current limit 200, the power limit 204, and the voltage limit 202 at a given speed of the motor 105. In other words, the braking torque generator 301 may calculate the currents supplied to the motor 105 based on the speed of the motor. Thus, the motor can generate a controlled braking torque 105 its current speed.

Moreover, the braking torque generator 301 may calculate the current values that satisfy both the voltage limit 202 to be applied to the motor 105 and the power limit 204 to prevent over-voltage on the capacitor 102 caused by the motor.

The DC link voltage controller 302 measures a voltage Vdc across the DC link capacitor 102 and outputs a change signal for the current value Iq. In response, the voltage across the capacitor 102 is adjusted to a certain level based on the measured voltage.

More specifically, the DC link voltage controller 302 may compare the measured voltage of the capacitor 102 with a predetermined reference voltage. The reference voltage is set for a wide voltage limited region without negatively impacting the stability of the capacitor 102. If the measured voltage of the capacitor 102 is smaller than the reference voltage, the change signal indicates to increase the current value Iq in the negative direction. If the measured voltage of the capacitor 102 is higher than the reference voltage, the change signal indicates to decrease the current value Iq.

The reference voltage may be, but is not limited to, a voltage limit value, Vdcmax, for example. For instance, if 450V is the maximum voltage that the capacitor 102 can nominally withstand without being damaged, the reference voltage may be set to be smaller than 450V, e.g., 350V or 380V. This ensures that the capacitor is protected even there is sudden changes in current. However, the reference voltage is not limited to these voltage values.

Further, the current Iq may be a current component among a plurality of current components supplied to the motor 105 and related to the braking torque generated from the motor 105. In some embodiments, it is preferred that the current value Iq is set high to achieve rapid braking and prevent over-voltage on the capacitor 102.

In accordance with the present disclosure, if the measured voltage of the capacitor 102 is smaller than the reference voltage, the current value Iq is increased in the negative direction so that braking of the motor 105 can be achieved in a short time. If the measured voltage across the capacitor 102 is higher than the reference voltage, the current value Iq is decreased to prevent over-voltage on the capacitor 102.

When the measured voltage on the capacitor 102 is smaller than the reference voltage, the capacitor 102 can safely respond to charging caused by the counter electromotive force of the motor 105. Thus, the motor 105 may be rapidly decelerated by increasing the current value Iq in the negative direction. Conversely, when the measured voltage is higher than the reference voltage, the current value Iq is decreased to protect the capacitor 102 from over-charging.

While the current value Iq is regulated to increase or decrease, it is preferred that a set of the braking operation points (e.g., \textcircled{1}, \textcircled{2}, \textcircled{3} as shown in FIG. 2) is not located on the circumference representing the power limit 204.

In other words, when controlling the braking of the motor 105, the current value Iq may be supplied as zero or a less negative (−) value on the graph. In addition, when the measured voltage of the capacitor is smaller the reference voltage, the motor 105 may be controlled such that the current value Iq is increased in the negative direction. Thus, the braking operation point set \textcircled{1}, \textcircled{2}, \textcircled{3} gradually lower in the vertical direction in the graph.

However, if the braking operation point set is located on the circumference representing the power limit 204, the voltage of the capacitor 102 may become unstable. Thus, the negative maximum can be reduced such that the current value Iq is not on the circumference representing the power limit 204.

If the current limiter 303 receives the current value Iq from the braking torque generator 301 and the change signal from the DC link voltage controller 302, the current limiter 303 may limit the maximum value and the minimum value of the current value Iq such that the current value Iq calculated from the DC link voltage controller 302 is not located on the circumference of the power limit 204. Information regarding the maximum value and the minimum value of the limited current value Iq may be supplied to the current controller 304.

If the measured voltage of the capacitor 102 is smaller than the reference voltage, the current value Iq may be increased in the negative direction. As shown in FIG. 2 the braking operation point set \textcircled{1}, \textcircled{2}, \textcircled{3} varies as Iq increases or decreases in the graph.

If the braking operation point set \textcircled{1}, \textcircled{2}, \textcircled{3} is located on the circumference representing the power limit 204, the voltage of the capacitor 102 may become unstable. The current limiter 303 may limit the negative maximum value of the current Iq so that it is not located on the circumference representing the power limit 204, despite the change signal indicative of increasing the current value Iq in the negative direction. Therefore, as shown in FIG. 2, the current applied to the motor 105 may be regulated so that the braking operation points for the motor 105 are not located on the circumference representing the power limit 204, thereby enabling the stable braking for the motor 105.

The current controller 304 may receive the current value Id from the braking torque generator 301 and receive the current value Iq having the maximum current value and the minimum current value regulated by the current limiter 303. The current controller 304 may then calculate voltage values Vd, Vq corresponding to the current value Iq. The calculated voltage may be applied to the motor 105.

Unlike the conventional braking unit, the current region to be applied to the motor 105 can be limited based on the speed of the motor 105 and the voltage measured on the capacitor 102. Accordingly, the current of the motor 105 can be controlled in a safe region and yet result in rapid motor deceleration. Consequently, the highest braking torque may be generated while the voltage of the DC link capacitor 102 is limited by the reference voltage.

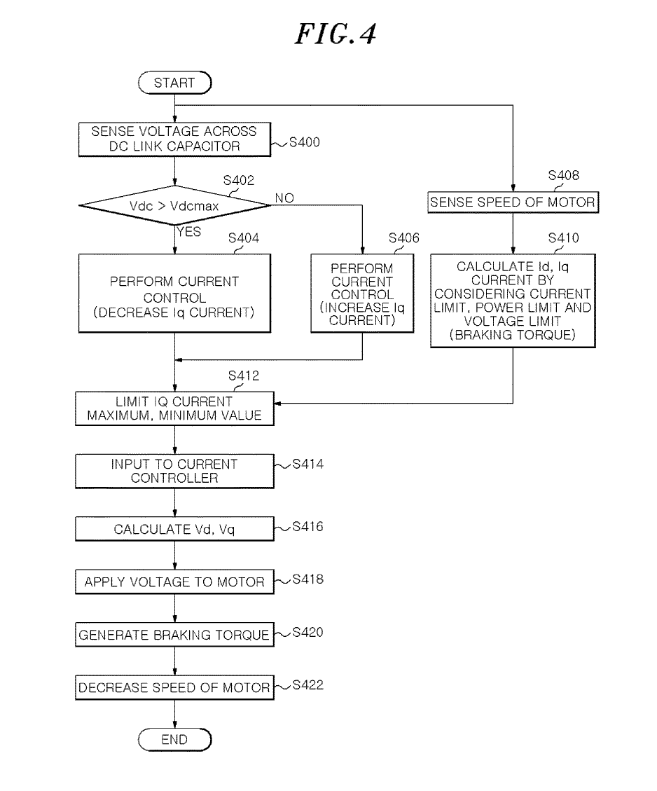

FIG. 4 is a flowchart illustrating an exemplary method of controlling motor braking in accordance with an embodiment of the present disclosure. Hereinafter, the embodiment of the present disclosure will be described in detail with reference to FIGS. 3 and 4.

At S400, the DC link voltage controller 302 measures the voltage across the DC link capacitor 102.

At S402, the DC link voltage controller 302 compares the measured voltage Vdc on the capacitor with the reference voltage. The reference voltage is set be wide while ensuring the stabilization of the capacitor 102. In this case, the reference voltage may be, for example, a voltage limit value Vdcmax.

If the measured voltage Vdc of the capacitor 102 is smaller than the reference voltage, at S404, the DC link voltage controller 302 outputs the change signal such the current value Iq increases in the negative direction. Further, when the measured voltage Vdc of the capacitor 102 is higher than the reference voltage, in operation S406, the DC link voltage controller 302 may output the change signal such the current value Iq may be decreased.

The current value Iq may be one of the current components applied to the motor 105. The current value Iq is associated with the magnitude of the braking torque generated from the motor 105. The current value Iq directly affects the braking efficiency. Therefore, when the measured voltage of the capacitor 102 is smaller than the reference voltage, the current value is increased in the negative direction and so rapid braking of the motor 105 can be achieved. However, when the measured voltage of the capacitor 102 is higher than the reference voltage, the current value Iq is decreased to prevent over-voltage on the capacitor 102. A change signal may be used to control the current limiter 303 which accordingly adjusts the Iq.

When the voltage on the DC link capacitor 102 is measured, at S408, the speed of the motor 105 is sensed from the braking torque generator 301 in the braking unit 300.

At S410, the braking torque generator 301 calculates the current values Id, Iq based on the speed of the motor 105. The calculated values satisfy the current limit 200, the power limit 204 and the voltage limit 202 as shown in FIG. 2.

More specifically, the braking torque generator 301 calculates the current to be applied to the motor 105 and determines the braking torque based on the speed of the motor 105. Moreover, the braking torque generator 301 may determine the current values Id, Iq which satisfy the current limit Imax 200 and the voltage limit Vmax 202 to be applied to the motor 105. The current values Id, Iq also satisfy the power limit Pg=Pr 204 such that the power generated from the motor 105 does not cause over-voltage on the capacitor 102.

The current value Id may be applied to the current controller 304, and the current value Iq may be applied to the current limiter 303.

Thus, the current limiter 303 receives the current value Iq from the braking torque generator 301 and the change signal from the DC link voltage controller 302. In response, the current limiter 303 limits the current Iq by the negative maximum value as the current value Iq increases in the negative direction. Thereafter, at S414, the current value Iq is applied to the current controller 304.

In other words, the current limiter 303 may limit the the current value Iq between the maximum and the minimum values as the current is adjusted based on the change signal. Therefore, the current applied to the motor 105 can be regulated such that the braking operation points for the motor 105 are not located on the circumference representing the power limit 204 as shown in FIG. 2. Consequently, stable braking of the motor 105 can be achieved.

At S416, the current controller 304 receives the current value Id from the braking torque generator 301 and receives the current value Iq with the regulated maximum value and minimum values from the current limiter 303. The current controller 304 calculates the voltage values Vd, Vq to be applied on the motor based on the current values Id and Iq. At S418, a voltage is applied to the motor 105 based on the calculated Vd and Vq.

As a result, at S420, the motor generates a braking torque. At S422, the speed of the motor 105 is decreased due to the braking torque.

In this embodiment, the process of S400 to S422 may be repeatedly performed until the motor 105 is stopped.

Therefore, according to embodiments of the present disclosure, the current to be applied to the motor 105 is dynamically limited based on the speed of the motor 105 and the voltage measured from the capacitor 102. This ensures that the motor 105 will operate at a controlled current. Thus, the highest safe braking torque can be advantageously used without causing overcharge on the DC link capacitor 102.

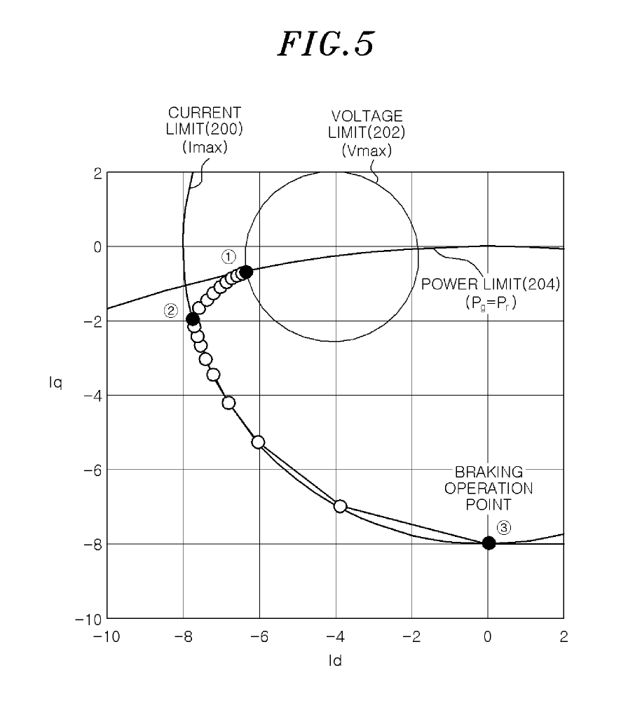

FIG. 5 is a sample plot illustrating braking torque operation point as a function of motor speed in accordance with an embodiment of the present disclosure.

Referring to FIG. 5, when braking of the motor 105 is performed considering the current limit 200, the power limit 202 and the voltage limit 204, the braking torque is generated according to a set of the braking operation points \textcircled{1}, \textcircled{2}, \textcircled{3} in FIG. 5.

For example, if braking is activated when the motor is at a high speed, the current corresponding to the braking operation point \textcircled{1} is supplied to the motor 105. Accordingly, the motor generates a braking torque satisfying the voltage limit 202 and the power limit 204. During the course of braking, the motor 105 decelerates by the counter electromotive force, and the voltage limit 202 increases correspondingly because it is in a narrow region. Thus, the braking operation point is shifted from the braking operation point \textcircled{1} to the braking operation point \textcircled{2}. The braking operation point \textcircled{2} corresponds to a situation where the current limit 200, the power limit 204, and the voltage limit 202 are all satisfied at the given motor speed.

If the braking operation is activated when the motor rotates at a speed lower than the speed at which all the current limit 200, the power limit 204, and the voltage limit 202 are satisfied, and since the region corresponding to the voltage limit 202 is sufficiently large, the voltage limit may be omitted from consideration in the determination of the braking operation point. Therefore, the braking operation can be performed according to a braking operation point that only satisfies the power limit 204 and the current limit 200. The braking operation point thus moves from braking operation point \textcircled{2} to the braking operation point \textcircled{3} due to the change of the motor speed.

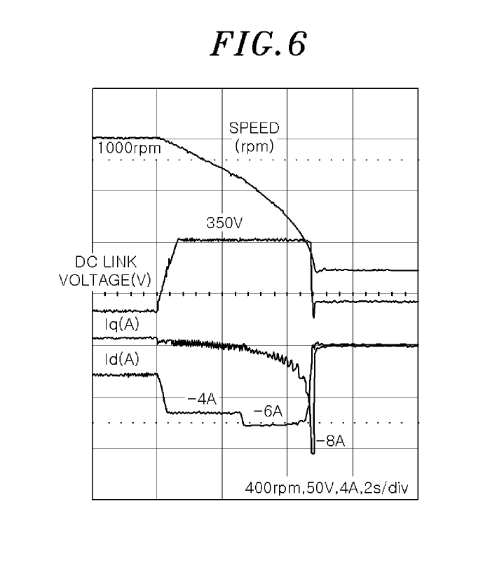

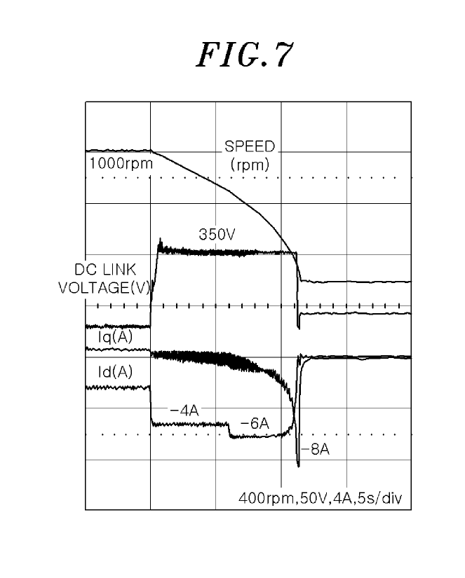

FIGS. 6 and 7 are waveforms showing variations of the DC link capacitor voltage, the dq-aixs current, and motor speed during motor braking in an exemplary washing machine in accordance with the embodiment of the present disclosure. In this case, FIG. 6 shows the waveforms sampled in a no-load condition and FIG. 7 shows the waveforms sampled in the load condition.

FIG. 6 shows that the motor speed decreases from 1000 rpm to 0 rpm as a result of braking. In this example, the voltage on the DC link capacitor 102 is limited to the maximum of 350V and so overcharge can be prevented. Also, Iq and Id change with selection of braking operation point shown in FIG. 5 based on the speed of the motor 105.

In accordance with the embodiment of the present disclosure, as a result of braking, the motor 105 completely stops in about 5 seconds from 1000 rpm in a no load condition as shown in FIG. 6; and the motor 105 completely stops in about 12 seconds from 1000 rpm with an approximately 15 kg load as shown in FIG. 7.

As described above in a motor braking operation according to the present disclosure, a braking torque of the motor is calculated and applied to the motor based on a voltage limiting condition of a DC link capacitor and a voltage limiting condition to be inputted from an inverter to the motor. The braking torque is thereby capable of stably controlling the braking of the motor regardless if the motor operates at a high speed or a low speed.

Although exemplary embodiments of the present disclosure are described above with reference to the accompanying drawings, those skilled in the art will understand that the present disclosure may be implemented in various ways without changing the necessary features or the spirit of the present disclosure.

Therefore, it should be understood that the exemplary embodiments described above are not limiting, but only an example in all respects. The scope of the present disclosure is expressed by claims below, not the detailed description, and it should be construed that all changes and modifications achieved from the meanings and scope of claims and equivalent concepts are included in the scope of the present disclosure.

From the foregoing, it will be appreciated that various embodiments of the present disclosure have been described herein for purposes of illustration, and that various modifications may be made without departing from the scope and spirit of the present disclosure. The exemplary embodiments disclosed in the specification of the present disclosure do not limit the present disclosure. The scope of the present disclosure will be interpreted by the claims below, and it will be construed that all techniques within the scope equivalent thereto belong to the scope of the present disclosure.

What is claimed is:

1. A motor braking unit of a washing machine, the motor braking unit comprising:
a braking torque generator configured to: sense a speed of a motor of the washing machine; and determine a first current to be supplied to the motor based on the speed, wherein the motor is operable to generate a braking torque responsive to the first current, wherein the first current comprises a first component and a second component;
a capacitor coupled to a direct current (DC) link; and
a DC link voltage controller configured to: perform a comparison on a measured voltage on the capacitor with a reference voltage; and generate a change signal based on the comparison, wherein the change signal is operable to regulate the first component.

2. The motor braking unit of claim 1, wherein the reference voltage corresponds to an upper limit voltage for preventing an over-voltage on the capacitor.

3. The motor braking unit of claim 1 further comprising:
a current limiter configured to: receive the change signal; and regulate a maximum value and a minimum value for the first component; and
a current controller configured to: calculate an adjusted first current to be supplied to the motor based on the second component that is determined by the braking torque generator, and a regulated first component.

4. The motor braking unit of claim 3, wherein, in response to a determination that the measured voltage on the capacitor is smaller than the reference voltage, the change signal indicates to increase the first component in a negative direction, and wherein, in response to a determination that the measured voltage is greater than the reference voltage, the change signal indicates to decrease the first component.

5. The motor braking unit of claim 3, wherein the maximum value and the minimum value of the first current are regulated to maintain a voltage on the capacitor to be less than or equal to the reference voltage.

6. The motor braking unit of claim 4, wherein the maximum value and the minimum value of the first current are regulated further based on a prescribed limit on power generated by the motor in response to application of the first current on the motor.

7. The motor braking unit of claim 4, wherein the braking torque generator is configured to determine the first current based on prescribed limits of a current and a voltage to be supplied by the motor, and further based on a prescribed limit on a power to be generated by a counter electromotive force of the motor in response to application of the first current on the motor.

8. The motor braking unit of claim 3, wherein the current controller is configured to: calculate a voltage corresponding to the adjusted first current; and supply a calculated voltage to the motor.

9. The motor braking unit of claim 1, wherein the braking torque generator determines the first current based on a current limit, the power limit and a voltage limit of the motor, and wherein the current limit, a power limit and the voltage limit are determined based on the speed of the motor.

10. The motor braking unit of claim 1, wherein the motor comprises a permanent magnet synchronous motor configured to drive a washing tub, and wherein the first component and the second component are in a dq-axis plane.

11. A motor braking method of a washing machine, wherein method comprising:
determining a first current to be supplied to a motor of the washing machine, wherein the first current comprises a first component and a second component;
supplying the first current to the motor to generate a braking torque;
measuring a first voltage on a capacitor coupled to a DC link;
comparing the first voltage with a reference voltage;
generating a change signal operable to regulate the first component based on the comparing;
regulating a maximum value and a minimum value of the first component responsive to the change signal;
determining a second current based on the second component of the first current, the first component of the first current, and a regulated maximum value and a regulated minimum value of the first component.

12. The motor braking method of claim 11, wherein the change signal increases the first component in a negative direction if the first voltage is smaller than the reference voltage; and wherein the change signal decreases the first component if the first voltage is greater than the reference voltage.

13. The motor braking method of claim 11, wherein the regulating comprises regulating the maximum value and the minimum value to maintain the first voltage on the capacitor to be equal to or smaller than the reference voltage.

14. The motor braking method of claim 11 further comprising:
after the determining the second current, calculating a voltage corresponding to the second current and supplying a calculated voltage to the motor.

15. The motor braking method of claim 11 wherein the first current value is determined based on a speed of the motor.

16. The motor braking method of claim 15 further comprising
determining a current limit, a power limit and a voltage limit based on the speed of the motor.

17. A washing machine comprising:
a washing tub;
a motor coupled to the washing tub and configured to drive rotation of the washing tub; and
a braking unit coupled to the motor to control braking of the motor, wherein the braking unit comprises:
a braking torque generator configured to: sense a speed of the motor; and determine a first current to be supplied on the motor, wherein the motor is operable to generate a braking torque responsive to the first current, wherein the first current comprises a first component and a second component;
a capacitor coupled to a direct current (DC) link;
a DC link voltage controller configured to: perform a comparison on a measured voltage on the capacitor with a reference voltage; and generate a change signal based on the comparison, wherein the change signal is operable to regulate the first component, wherein the reference voltage corresponds to an upper limit voltage for preventing an over-voltage on the capacitor;
a current limiter configured to: receive the change signal; and determine a maximum value and a minimum value for the first component; and
a current controller configured to: calculate the second component based on the maximum value and the minimum value for the first component and a value of the second component that is determined by the braking torque generator.

18. The washing machine of claim 17, wherein, in response to a determination that the measured voltage on the capacitor is smaller than the reference voltage, the change signal indicates to increase the first component in a negative direction, and wherein, in response to a determination that the measured voltage is greater than the reference voltage, the change signal indicates to decrease the first component.

19. The washing machine of claim 17, wherein the maximum value and the minimum value of the first component are determined based on the reference voltage, and further based on a prescribed limit on a power to be generated by the motor in response to application of the first current on the motor.

20. The washing machine of claim 17, wherein the braking torque generator is configured to determine the first current based on based on a current limit, a power limit and a voltage limit of the motor, and wherein the current limit, the power limit and the voltage limit are determined based on a speed of the motor.
